(19) United States
(12) Patent Application Publication
(10) Pub. No.: US 2004/0143585 A1
(43) Pub. Date: Jul. 22, 2004

(54) Data processing device for the preparation of a goods catalogue in the form of a graphics file

(76) Inventor: Urs Antener, Stusslingen (CH)

Correspondence Address: BROWDY AND NEIMARK, P.L.L.C., 624 NINTH STREET, NW, SUITE 300, WASHINGTON, DC, 20001-5303, US

(21) Appl. No.: 10/471,876

(22) PCT Filed: Mar. 8, 2002
(86) PCT No.: PCT/CH02/00141

(30) Foreign Application Priority Data
Mar. 14, 2001 (CH) 468/01

(51) Int. Cl. G06F 17/00

(52) U.S. Cl. 707/100

(57) ABSTRACT

The invention relates to a data processing device for the preparation of a goods catalog in the form of a graphics file on the Internet for the direct use of the goods catalog for the execution of orders.

The invention relates to a data processing device for the preparation of a goods catalog in the form of a graphics file on the Internet for the direct use of the goods catalog for the execution of orders.

The Internet is finding increasing use as a promotional and ordering platform for companies marketing goods. Applications implemented in data processing devices are known for this purpose which allow a user of a computer connected to the Internet to fill so-called shopping baskets with the goods he requires. The problem arises here that these applications are database applications which do not readily work together with known catalogs on paper. Hitherto, it has been necessary in addition to producing a catalog on paper for the Internet site to require the separate input of relevant data into the structure prescribed by the data processing device. This is a costly exercise beyond the means of small- and medium-sized enterprises. In many cases, therefore, just a partial offering is input in order at least to have some Internet presence to speak of.

One solution of the prior art is to scan in whole paper catalogs and to display them as a graphics and/or text file or to create individual web pages directly from desktop publishing programs or word-processing on individual web pages, which can be selected from a list of contents as in a book. The individual placing the order notes down the data required for his order (order number, color codes, package sizes, etc.) on paper and then opens up an order page which provides the known interface for entering said data for example as part of a cgi application or Java Applet, etc.

Starting from this prior art, an object of the invention is to provide a method and a device of the type stated at the outset which each simply allow the provider of goods/services based on a paper catalog to present the content of its catalog on the Internet in a transparent fashion to the purchaser of the goods/services.

In the case of a method, this object is achieved according to the invention by the graphics file or text file being subdivided into a number of sections corresponding to catalog pages of the goods catalog, by a number of fields of a catalog page, the fields corresponding to graphics areas, being provided in each section, the field content corresponding to an element from the group comprising page numbering, section headings, product images, product names, keywords, product description, additional characteristics, order number, price or other product-specific characteristics, by the content of said fields being stored in a database either as a graphics area or converted by analysis into alphanumeric characters, and by the content of said fields or of some of said fields being displayed on a web page provided for executing an order and this web page also being provided with hyperlinks for selecting and placing an order.

In this context, graphics area is generally understood as an area or region in a graphics file or text file.

The invention is now described in more detail with reference to the drawings on the basis of an exemplary embodiment. In the drawings:

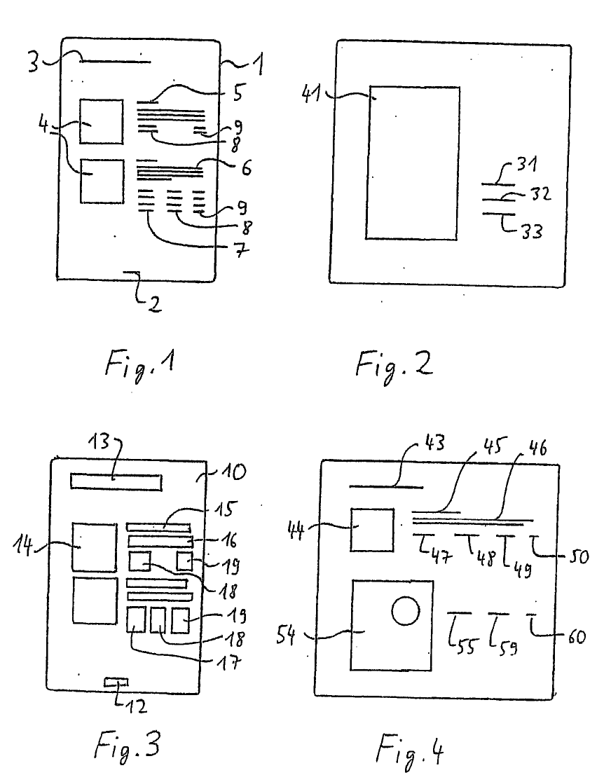

FIG. 1 is a schematic diagram of an example of a catalog page such as to illustrate the necessary and/or optional content for a product/goods item/service on such a catalog page,

FIG. 2 is a schematic diagram of an example of the presentation of a catalog page on a web page according to the prior art,

FIG. 3 shows a graphics mask for use with a catalog page in accordance with FIG. 1 when executing the method according to the invention, and

FIG. 4 is a schematic diagram of an example of the presentation of a catalog page on a web page in accordance with an exemplary embodiment of the invention.

FIG. 1 is a schematic diagram of an example of a catalog page 1 such as to illustrate the necessary and/or optional content for a product/goods item/service on such a catalog page 1. Catalogs are generally still produced in paper form today. The paper form establishes the reference and is a reproduction of the goods/services catalog offered by the producer of the catalog. Even those who place orders on the Internet value the opportunity to work in the paper version of the catalog that is in most cases also available.

In addition to the introduction, terms of business and lists of contents, a catalog essentially comprises catalog pages 1 containing more or less standardized information preferably arranged always in the same location on each page. This includes page numbering 2 and possibly section headings 3. All this written information is indicated by lines. Each page, moreover, contains a certain number of products. These are shown for example in an image 4. Information on this product is provided in a certain relation to this image 4, represented by a rectangle. This information includes, not necessarily in this arrangement, name/keyword 5, description 6, additional characteristics 7 such as color or packaging unit, order number 8 and price 9. In addition to the information stated here, further elements may also be referenced. The order number 8 and price 9 are essential. An image 4 may or may not be provided. In the absence of an image, a name/keyword 5 is required for the product and a description 6 is desirable.

FIG. 2 is a schematic diagram of an example of the presentation of a catalog page 1 on a web page according to the prior art. The catalog page 1 has been scanned in and is present in a graphics format or in a text file. This will in particular be a file 41 in a known format which can be read by many browsers intrinsically or by means of a plug-in. This may be by way of non-limiting example: TIFF, GIF, JPEG, PDF (from Adobe Systems). The database may also be created starting from other formats such as HTML, XML or print formats. Graphics file 41 is to be understood to mean any graphically displayable and interpretable file, in short any file with which graphical information can be displayed.

In addition to the presentation of the catalog page 1 as a single graphics file 41, hyperlinks are also provided here for example, which afford the facility to scroll a page forwards, 31, to scroll a page backwards, 32, and to switch to an order form, 33.

One exemplary embodiment of the data processing device for the preparation of a goods catalog in the form of a graphics file on the Internet for the direct use of the goods catalog for the execution of orders works as follows and is first described in association with FIG. 3.

FIG. 3 shows a graphics mask for use with a catalog page in accordance with FIG. 1 when executing the method according to the invention. The data processing device comprises a first database in which, for every catalog managed by it, are stored one or more graphics masks 10 for each different catalog page 1. A graphics file corresponding to a catalog page is then sent to the data processing device. The data processing device identifies the mask 10 to be used either by a reference to the page number, section number or by a graphical comparison of specific characteristics of the graphics file. The mask 10 comprises a series of fields 12 to 19 corresponding in reference number order to the page numbering 2, section heading 3, images 4, name/keyword 5, description 6, additional characteristics 7, order number 8 and price 9. These fields 12 to 19 are represented by rectangles, since they span a two-dimensional space, in which they read in the corresponding graphical content of the catalog page 1. The image 4 is transferred over to field 14. The other fields 12, 13 and 15 to 19 are converted into alphanumeric characters by means of an OCR process (in the case of a graphics file) known per se. The data contents of all fields are stored in the data processing device in correspondingly defined data base fields of a second database, which comprises the catalog. The order number 8 or item number can always be located in a specific column and/or in a specific area, the remaining information then being displayed for example at defined distances from this initial item of information. It is also possible for the fields to be identified using various recurring characteristics, without there being specific or precise area definitions. These characteristics may be text components, e.g. Item No. or No. or N^{o}. They may also be fonts, font sizes or other components definable by graphical analysis.

The page numbering 2, which is preferably provided as a reference characteristic for classifying the catalog page 1, can in addition to serial numbering be provided by section with or without letters. It is also possible for individual catalog pages to be pure information pages which are not included in the online catalog.

Advantageously, the provider will supply a database with order numbers and e.g. prices in addition to the graphics file, so that the database constructed by the data processing device from the graphics file or text file can be verified.

After the abovementioned information has been read in, an index database is constructed by compiling the sections 3, product names 5 or keywords 5 and certain words from the description for a search term query. So-called noise words such as pronouns and verbs are deleted from this word stock. Characters such as hyphens (word-splitting), quotation marks and periods, etc. can also be identified and deleted.

For better ease of alphabetical finding of products, colloquialisms or regionalisms (water heater=hot water heater=boiler=electric boiler) can also be added from a synonym word table.

The content of the second database can be accessed by a user's browser when the user opens the web page of the catalog provider using the data processing device. The data contained in the second database are then conveyed for example in accordance with what is depicted in FIG. 4. FIG. 4 is a schematic diagram of two such examples of the presentation of a catalog page 1 on a web page in accordance with exemplary embodiments of the invention. In practice, one or the other solution will advantageously be implemented on a web page. The file 44 created from image 4 is displayed alongside the section title 43. Also present from the database are the fields comprising product name 45, description 46, additional characteristics 47, order number 48 and price 49. Furthermore, a box 50 is preferably provided, which when clicked on causes the particular product to be added to a shopping basket.

The other procedure is to display a complete or cut file 54 containing image and other information in graphical form alongside which the correspondingly located product name 55 (or order number 58), price 59 and a clickable box 60 from the database are provided. In place of or in addition to the box 60, the image may also contain one or more so-called hotspots 70.

In a search term query, a graphics page can be displayed directly at the corresponding level, i.e. not beginning at the start of the page. Where the product pages are fully included in the database, a plurality of hits can be displayed directly on a web page in succession, since in that case images 4 and additional elements are stored in the database as separate elements.

Once all catalog pages 1 have been processed in accordance with the procedure described above, the catalog exists in an online version. The data processing device advantageously has a further processing function. The provider of said catalog can send new catalog pages 1 to the data processing device at any time. The latter identifies e.g. from the page number that this is a replacement page or a new page, reads the page into the database and supplements, corrects or replaces product data sets.

In a more simple embodiment not shown in the drawings, the graphics pages are fully displayed and the database contains the order numbers 8 and an indication of where on the graphics page they are located. This makes it possible to provide so-called hotspots 70 in these areas on the web page so that the mouse pointer, when moved over these areas, changes to indicate that the associated product can be ordered with a click.

The item prices 9 may also be transferred over in place of or in addition to a separate database supplied by the provider. A graphics element can then additionally be faded into the original graphics file if the price disclosed on the graphics page does not correspond to the price disclosed from the database. For one language area, it is also possible to replace prices in different currencies with corresponding graphics elements or text elements or to transfer these elements over from an external database. In principle, it is technically possible to modify every graphical or every text element for a user group down to an individual (password-identified) user.

1. A method for the preparation of a goods catalog in the form of a graphics file or text file on the Internet for the direct use of the goods catalog for the execution of orders, characterized
in that the graphics file or text file is subdivided into a number of sections corresponding to catalog pages of the goods catalog,
in that a number of fields of a catalog page, the fields corresponding to graphics areas, are provided in each section, the field content corresponding to an element from the group comprising page numbering, section headings, product images, product names, keywords, product description, additional characteristics, order number, price or other product-specific characteristics,
in that the content of said fields is stored in a database either as a graphics area or converted by analysis into alphanumeric characters, and
in that the content of said fields or of some of said fields is displayed on a web page provided for executing an order, and this web page is also provided with hyperlinks for selecting and placing an order.

2. The method as claimed in claim 1, characterized in that the graphics file is in TIFF, GIF, JPEG, PDF, HTML, XML format or in a printer-specific format.

3. A data processing device for the preparation of a goods catalog in the form of a graphics file or text file on the Internet for the direct use of the goods catalog for the execution of orders, having a computer device, to which a memory is connected, in which memory a graphics file or text file can be stored, that the graphics file or text file can be subdivided by means of the computer into a number of file fragments containing sections, corresponding to catalog pages of the goods catalog, that each file fragment can be subdivided into a number of fields of a catalog page, the fields corresponding to graphics areas, the field content corresponding to an element from the group comprising page numbering, section headings, product images, product names, keywords, product description, additional characteristics, order number, price or other product-specific characteristics, that the content of said fields can be stored in fields of a database either as a graphics area or converted by analysis into alphanumeric characters, and that the content of said fields or of some of said fields can be displayed and opened on a web page provided for executing an order and this web page is also provided with hyperlinks for selecting and placing an order.
